(19) United States
(12) Patent Application Publication
(10) Pub. No.: US 2019/0094331 A1
(43) Pub. Date: Mar. 28, 2019

(54) SYSTEM AND METHOD OF INFRASTRUCTURE SENSOR SELF-CALIBRATION

(71) Applicant: Continental Automotive Systems, Inc., Auburn Hills, MI (US)

(72) Inventor: Ganesh Adireddy, Bloomfield Hills, MI (US)

(73) Assignee: Continental Automotive Systems, Inc., Auburn Hills, MI (US)

(21) Appl. No.: 16/041,230

(22) Filed: Jul. 20, 2018

Related U.S. Application Data
(60) Provisional application No. 62/562,891, filed on Sep. 25, 2017.

(51) Int. Cl. G01S 5/02; G01S 5/16; G01S 1/68

(52) U.S. Cl. CPC G01S 5/0263; G01S 5/16; B60R 2021/0025; G01S 5/021; G01S 1/68

(57) ABSTRACT

A device, method and software program for sensor self-calibrating are disclosed, including sensing, by sensors, objects in at least one field of view and generating sense data from the sensing; detecting, from the sense data, at least one marker disposed in a fixed position within the at least one field of view; for each marker detected, extracting position information of the marker and associating the marker with the extracted position information therefor; and calibrating the sensors based upon the extracted position information for each marker detected.

### CROSS REFERENCE TO RELATED APPLICATION

The present application claims the benefit of U.S. provisional application 62/562,891, filed Sep. 25, 2017, entitled “System and Method of Infrastructure Sensor Self-Calibration,” the content of which is hereby incorporated by reference herein in its entirety.

### FIELD OF INVENTION

The present invention generally relates to an infrastructure for facilitating the operation of vehicles in a geographical region having the infrastructure, and particularly to a system, software program and method for self-calibrating infrastructure sensors.

### BACKGROUND

Vehicle-to-vehicle (V2V) communication and vehicle-to-infrastructure (V2X) communication are becoming more prominent in controlling vehicles, particularly for driving-safety and driving-assistance systems. In controlling driving-safety and driving-assistance systems, it is advantageous to have the most precise as possible knowledge of the location of vehicles and other objects with which vehicles may interact.

Infrastructure sensing devices involved with V2X communication include sensing devices which sense objects within the field of view of the devices. Such a sensing device may, for example, be integrated with a traffic light or be a standalone object mounted on a pole, building or other structure. Despite infrastructure sensing devices being stably mounted and/or secured, the location of such devices may change over time. For example, the position (latitude, longitude and orientation) of a traffic light may vary based upon temperature, wind, the weight of snow or ice on the light or the structure on which the traffic light is mounted, etc. In addition, vision based sensors need to be recalibrated from time to time.

### SUMMARY

According to example embodiments, there is disclosed a monitor device, including: a processing unit; memory coupled to the processing unit; a sensor arrangement coupled to the processing unit, the sensor arrangement comprising a plurality of sensors configured to sense objects in at least one field of view of the sensors; and program code stored in the memory. The program code has instructions which, when executed by the processing unit cause the processing unit to receive, from the sensors, sense data of objects in the at least one field of view of the sensors; detect, in the sense data, at least one marker disposed in a fixed position within the at least one field of view; for each marker detected, extract position information between the marker and the monitor device, and associate the marker with the extracted position information; and calibrate the sensors in the sensor arrangement based upon the extracted position information.

The monitor device may include a traffic light having a plurality of lights coupled to the processing unit for control thereby.

In an example embodiment, the monitor device includes a transceiver coupled to the processing unit, wherein the instructions stored in the memory, when executed by the processing unit, further cause the processing unit to, following the calibrating of the sensors, receive from the sensors second sense data of objects in the at least one field of view of the sensors, detect, from the second sense data, the objects in the at least one field of view of the sensors, and extract position information of the objects of the second sense data relative to the monitor device based in part upon the extracted position information for each marker, and to communicate, using the transceiver, information pertaining to the sensed objects of the second sense data and the extracted position information thereof. The transceiver then communicates the information pertaining to the sensed objects of the second sense data and the extracted position information thereof to one or more other monitor devices. The transceiver also communicates the information pertaining to the sensed objects of the second sense data and the extracted position information thereof to one or more vehicles within a communication range of the monitor device.

The instructions stored in the memory, when executed by the processing unit, may further cause the processing unit to, following the calibrating of the sensors, receive from the sensors a second sense data of objects in the at least one field of view of the sensors, detect, from the second sense data, the objects in the at least one field of view of the sensors and extract position information of the objects of the second sense data relative to the monitor device based at least in part upon the extracted position information for each marker.

The monitor device may further include a transceiver coupled to the processing unit, wherein the at least one marker may include at least one passive marker and at least one active marker, and wherein the instructions stored in the memory, when executed by the processing unit, further cause the processing device to receive, via the transceiver, position information from the at least one active marker, associate the at least one active marker with the position information received therefrom; and calibrate the sensors in the sensor arrangement based upon the position information of the at least one active marker.

In an example embodiment, the at least one field of view of the sensors includes a plurality of fields of view thereof, such that the instructions for the receiving, the detecting, the extracting and the calibrating are repeated for each field of view. In particular, the instructions for the receiving, the detecting, the extracting and the calibrating are performed for a first field of view of the plurality of fields of view before the instructions for the receiving, the detecting, the extracting and the calibrating are performed for a second field of view of the plurality of fields of view.

In other example embodiments, a calibrating method includes sensing, using sensors, one or more first objects in at least one field of view and generating sense data from the sensing; detecting, from the sense data, at least one marker disposed in a fixed position within the at least one field of view; for each marker detected, extracting position information corresponding to the marker relative to the sensors, and associating the marker with the extracted position information therefor; and calibrating the sensors based upon the extracted position information for each marker detected.

The method may further include, following the calibrating, sensing one or more second objects in the at least one field of view and generating second sense data from the sensing; and extracting position information of the one or more second objects relative to the sensors based upon the extracted position information for each marker detected. The method may include sending information pertaining to the second objects and the extracted position information thereof to one or more monitor devices or one or more vehicles within a communication range.

The method may include receiving position information from at least one active marker and associating the at least one active marker with the position information received therefrom, wherein calibrating the sensors is also based upon the position information of the at least one active marker.

Following the calibrating, the method may include sensing, by the calibrated sensors, one or more second objects in the at least one field of view and generating second sense data from the sensing; and extracting position information of the one or more second objects relative to the sensors.

In example embodiment, the at least one field of view includes at least a first field of view and a second field of view, and the sensing, the detecting, the extracting and the calibrating are performed for each field of view. In particular, the sensing, the detecting, the extracting and the calibrating are performed for the first field of view prior to the sensing, the detecting, the extracting and the calibrating are performed for the second field of view.

Other example embodiments include a software program stored in a non-transitory medium and having instructions which, when executed by a processing unit coupled to a sensor arrangement, cause the processing unit to: receive, from the sensor arrangement, sense data of objects in the at least one field of view of the sensor arrangement; detect, in the sense data, at least one marker disposed in a fixed position within the at least one field of view; for each marker detected, extract position information between the marker and the monitor device, and associate the marker with the extracted position information; and calibrate sensors in the sensor arrangement based upon the extracted position information.

The software program may further include instructions which, when executed by the processing unit, cause the processing unit to receive position information from at least one active marker and associate the at least one active marker with the position information received therefrom, wherein the instructions for calibrating the sensors calibrate the sensors based in part upon the position information of the at least one active marker. The at least one field of view may include at least a first field of view and a second field of view, and the instructions cause the sensing, the detecting, the extracting and the calibrating to be performed for each field of view.

### BRIEF DESCRIPTION OF THE DRAWINGS

Aspects of the invention will be explained in detail below with reference to exemplary embodiments in conjunction with the drawings, in which:

FIG. 1 is a block diagram of an intelligent traffic light according to an example embodiment;

FIG. 2 is a top view of a street intersection having traffic lights of FIG. 1;

FIG. 3 is a flowchart illustrating an operation of the traffic light of FIG. 1, according to an example embodiment; and

FIG. 4 is a block diagram of a sensing device according to another example embodiment.

### DETAILED DESCRIPTION

The following description of the example embodiments is merely exemplary in nature and is in no way intended to limit the invention, its application, or uses.

Example embodiments account for positional changes of infrastructure sensing devices so that measurements determined thereby are as accurate as possible.

The example embodiments presented herein are generally directed to a system, software product and operating method for improving positional calculations of vehicles and other objects by providing self-calibration of infrastructure sensors. The system includes one or more markers disposed at fixed locations within the field of view of an infrastructure sensor. A central processing unit (CPU) associated with the infrastructure sensor extracts the distance and orientation between each marker and the sensor and calibrates or recalibrates the sensor based at least in part upon the extracted marker distance and orientation. In this way, any movement of the infrastructure sensor, such as due to a change in temperature, may be accounted for with a subsequent calibration operation, thereby resulting in more accurate positional determinations for use in controlling traffic and the operation of vehicles therein.

Example embodiments of the present disclosure are directed to improving the accuracy of distance and orientation calculations of infrastructure sensing devices.

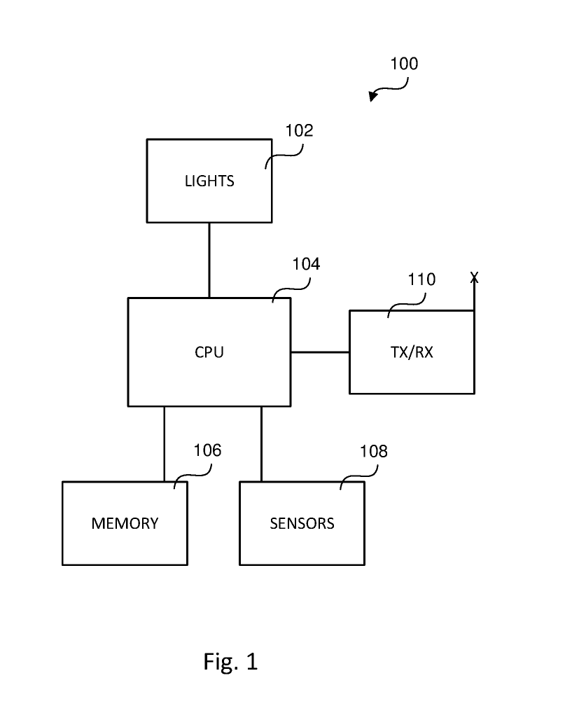

FIG. 1 is a block diagram depicting a traffic light 100 according to an example embodiment. Traffic light 100 includes lights 102, the sequenced illumination of which provide instructions to drivers of vehicles entering an intersection, as is widely known. Each light 102 may be a single light or formed from a plurality of smaller lighting devices, such as light emitting diodes.

Lights 102 are coupled to and controlled by a central processing unit (CPU) 104. CPU 104 may be formed from one or more processors, processing elements and/or controllers. Memory 106 is coupled to CPU 104 and includes nonvolatile memory having stored therein program code which, when executed by CPU 104, results in, among other things, CPU 104 controlling the activation and deactivation of lights 102 in a certain timing sequence so as to control traffic passing through the intersection to which traffic light 100 is associated.

As shown in FIG. 1, traffic light 100 includes a sensor arrangement 108 coupled to CPU 104. In an example embodiment, sensor arrangement 108 includes one or more sensors, cameras and/or other devices. The output of sensors of sensor arrangement 108 is provided to CPU 104 which detects, among other things, the presence of objects within the field of view of the sensors and determines the distances thereto, as described in greater detail below. The objects and their corresponding determined distances may be used by traffic light 100 in controlling the activation and deactivation of lights 102; by vehicles within a communication range of the traffic light 100 in, for example, controlling the operation of such vehicles; and by other traffic lights in the same geographical area as traffic light 100.

Traffic light 100 further includes transceiver 110 coupled to CPU 104 for communicating information over the air interface. Transceiver 110 includes a transmitter and a receiver. In an example embodiment, traffic light 100 may utilize the Dedicated Short Range Communication (DSRC) protocol in communicating over the air interface. It is understood, however, that traffic light 100 may utilize other known communication protocols, including code division multiple access (CDMA), global system for mobile (GSM), long-term evolution (LTE), wireless local area network (WLAN) and/or Wi-Fi, and/or protocols which have not yet been developed for communicating over the air interface.

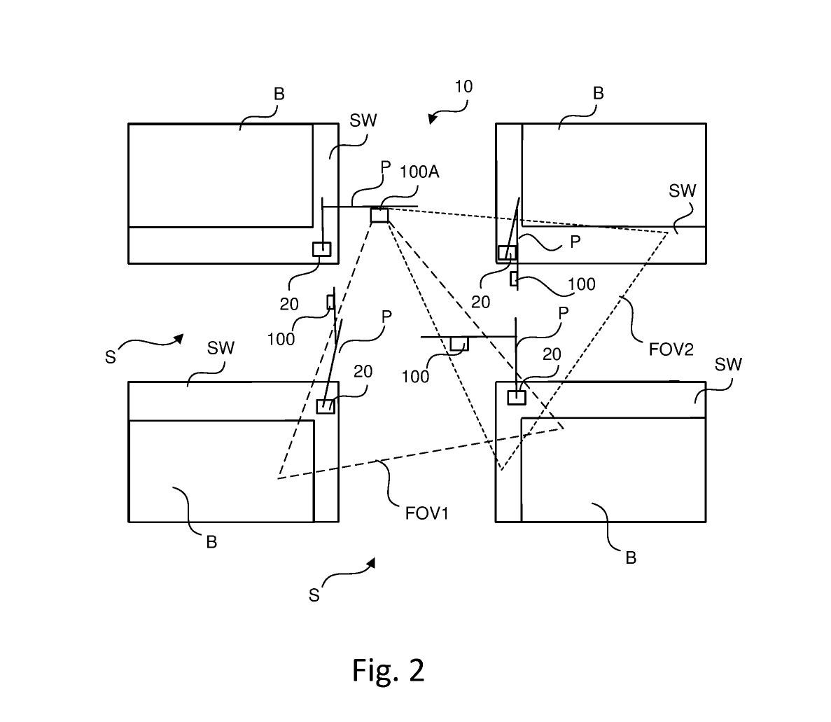

FIG. 2 illustrates a bird's eye view of an intersection of streets S bounded by city blocks B having sidewalk/curb areas SW in which an infrastructure system 10 is disposed. In this example embodiment, infrastructure system 10 includes a plurality of traffic lights 100 for generally controlling the flow of traffic through the intersection. Infrastructure system 10 includes four traffic lights 100 but it is understood that more or less traffic lights 100 may be utilized. Each traffic light 100 depicted in FIG. 2 may be implemented as shown in FIG. 1. Alternatively, traffic lights 100 associated with the intersection may share a common transceiver 110, CPU 104, and/or memory 106. In FIG. 2, each traffic light 100 is mounted on and otherwise suspended from a light pole P formed of a vertical pole segment and a horizontal pole segment connected thereto.

Because each traffic light 100 of infrastructure system 10 includes a sensor arrangement 108, each traffic light 100 has at least one field of view FOV associated with the sensor arrangement 108. FIG. 2 illustrates one traffic light 100A having at least two fields of view FOV1 and FOV2 associated with the sensor arrangement 108 of the traffic light 100A. The field(s) of view FOV of only one traffic light 100 is illustrated in FIG. 2 for simplicity, and it is understood that any traffic light 100 depicted may have one or more fields of view FOV for monitoring activity.

Infrastructure system 10 includes markers 20, each of which is disposed in a fixed location within at least one field of view FOV of at least one traffic light 100. FIG. 2 shows four markers, three of which are located in the fields of view FOV1, FOV2 of traffic light 100A. A fourth marker 20 is located at the base of pole P of traffic light 100A and is not within the fields of view FOV1, FOV2 of traffic light 100A. Markers 20 are anchored in a fixed position at or near the ground level. In one example embodiment, one or more markers 20 is secured to a light pole P about 1 ft to about 3 ft from the ground, but it is understood that markers 20 may have other elevations. Being elevated above ground level allows for markers 20 to be detectable during periods of snow accumulation. Markers 20 may have a predetermined size, shape and/or orientation relative to traffic light 100 which lends to relatively simpler identification by CPU 104. In an example embodiment in which the sensors in sensor arrangement 108 are cameras, markers 20 may have a predetermined color, such as a unique or distinct color. In an example embodiment in which the sensors in sensor arrangement 108 utilizes radar, markers 20 are reflective.

In some example embodiments, markers 20 are passive markers and are sensed by sensor arrangement 108 employing optical (e.g., LiDAR), RF (e.g., radar), thermal, and/or other similar sensing technologies. In some other example embodiments, markers 20 are active markers and actively send marker position data (longitude, latitude and orientation) to sensor arrangement 108 of traffic lights 100. In this example embodiment, markers 20 may include a transceiver, similar to transceiver 110 of traffic light 100, for transmitting position data to traffic lights 100 over the air interface. Each marker 20 may be configured, for example, to transmit its position data to nearby traffic lights 100 on a periodic or otherwise regular basis. Alternatively, each marker 20 may send its position data to nearby traffic lights 100 over the air interface in response to receiving a request from a traffic light 100.

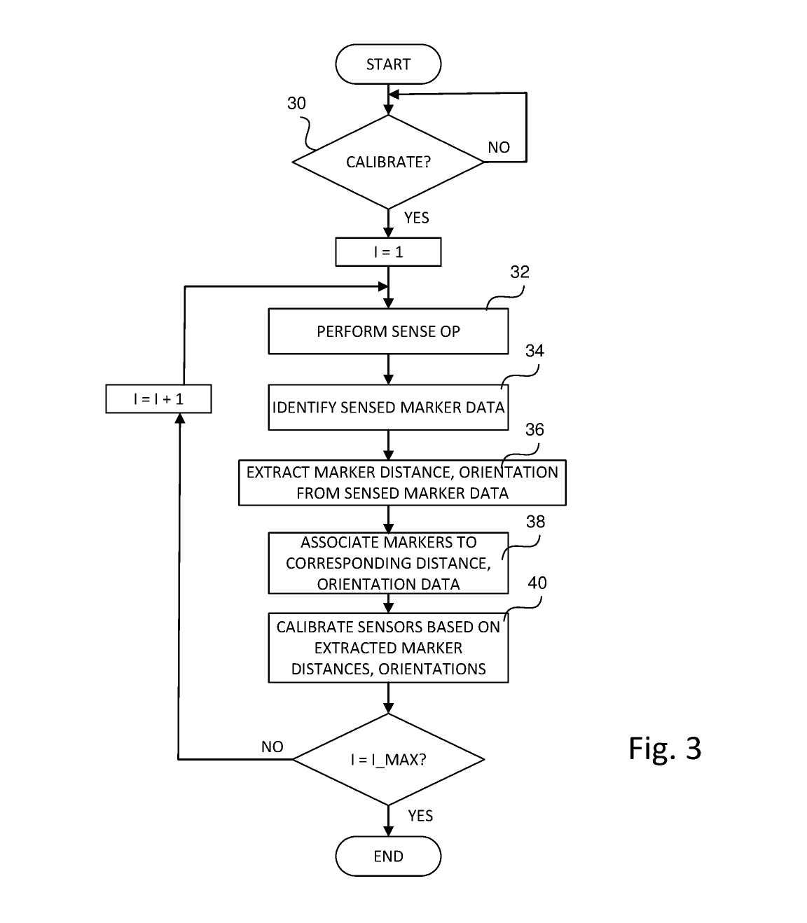

The operation of traffic light 100A of system 10 will be described with respect to FIG. 3. During normal operation of traffic light 100A, in which each traffic light 100 controls lights 102 thereof and communicates with other traffic lights 100 and/or vehicles within range, a determination is made at 30 that traffic light 100A is to calibrate sensors of the sensor arrangement 108 thereof. CPU 104 controls sensors in sensor arrangement 108 to sense objects in the fields of view FOV1 and FOV2. In an example embodiment, objects are sensed and actions taken with respect to one field of view FOV at a time. In this case, CPU 104 senses objects first in field of view FOV1 and sensed data is generated. Next, CPU 104 identifies markers 20 in field of view FOV1 at 34 from the sensed data. CPU 104 may identify markers 20 in field of view FOV1 based in part upon information saved in memory 106 pertaining to the location of markers 20. For each marker 20 identified, CPU 104 then extracts at 36 from the sensed data marker distance and orientation information relative to sensor arrangement 108 and/or traffic light 100A itself. CPU 104 may utilize any of a number of techniques for calculating the distance and orientation of markers 20 relative to traffic light 100A, and the particular technique(s) performed may be based upon the type of sensors of sense arrangement 108.

With newly extracted marker position information, CPU 104 associates at 38 the position information (distance and orientation) for each marker 20 in the field of view FOV1. This may involve CPU 104 saving in memory 106 the position information, and replacing previously utilized position information in future object location calculations. Next, at 40 CPU 104 calibrates the sensors of sensor arrangement 108 with sense data in field of view FOV1. This step may involve comparing the known position information for each marker 20, which may be stored in memory 106 of the corresponding traffic light 100A, with the corresponding newly extracted marker position information from step 36, such that the sensors of sensor arrangement 108 are calibrated based upon each comparison. This process of steps 32-40 is repeated for each field of view FOV associated with sensor arrangement 108 of traffic light 100A. With sensor arrangement 108 fully calibrated, future position/location determinations (distance and orientation) of objects sensed in the sensors' fields of view FOV will be more accurate, which will result in traffic decisions by system 10 and vehicles communicating therewith being made with more accurate information.

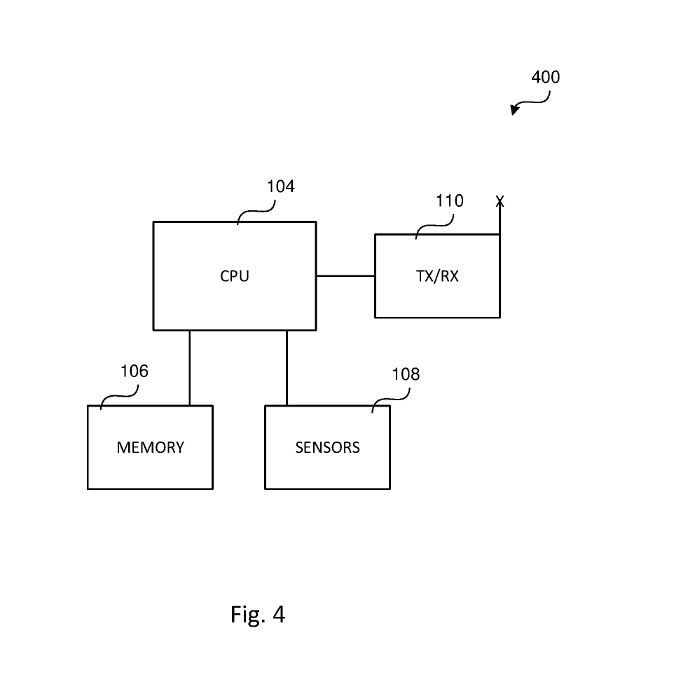

As described above, traffic lights 100 monitor objects at or around intersections via the use of sensor arrangement 108. In another example embodiment, a sensor arrangement 108 may be deployed along streets and/or street intersections to which no traffic light 100 is associated. For example, a sensing or monitoring device 400 (FIG. 4) may include much of the components of traffic light 100 of FIG. 1, including a CPU 104, memory 106, sensor arrangement 108 and transceiver 110. However, sensing device 400 does not include lights 102 or the program code in memory 106 for determining the timing sequence therefor. Instead, CPU 104 of sensing device 400, by executing program code stored in memory 106 thereof, simply senses objects in the field of view FOV of sensors of sensor arrangement 108, identifies any sensed markers 20 in its field of view FOV, extracts position information of such markers, calibrates sensors in sensor arrangement 108 of sensing device 100 based upon the extracted marker position information, and continues sensing objects in the field of view FOV using the calibrated sensors.

Vision sensors operate well and report accurate detections, but need calibration and recalibration. Permanent infrastructure and/or infrastructure devices at intersections, such as traffic light poles, street light poles, etc., have fixed and known locations, i.e., fixed distances from the infrastructure sensors at the intersections. Markers are placed along or near the ground plane at the base of traffic lights, street light poles, etc., and are visible to the sensors for associating each marker with its X and Y distances from the sensor. A sensor may use a hard-coded X and Y distance along with the known and fixed visible markers in its field of view to calibrate itself. This enables vision sensors (e.g., camera, radar) to self-calibrate using the fixed markers on infrastructure devices.

The example embodiments have been described herein in an illustrative manner, and it is to be understood that the terminology which has been used is intended to be in the nature of words of description rather than of limitation. Obviously, many modifications and variations of the invention are possible in light of the above teachings. The description above is merely exemplary in nature and, thus, variations may be made thereto without departing from the spirit and scope of the invention as defined in the appended claims.

What is claimed is:

1. A monitor device, comprising:
a processing unit;
memory coupled to the processing unit;
a sensor arrangement coupled to the processing unit, the sensor arrangement comprising a plurality of sensors configured to sense objects in at least one field of view of the sensors; and
program code stored in the memory and having instructions which, when executed by the processing unit cause the processing unit to
receive, from the sensors, sense data of objects in the at least one field of view of the sensors;
detect, in the sense data, at least one marker disposed in a fixed position within the at least one field of view;
for each marker detected, extract position information between the marker and the monitor device, and associate the marker with the extracted position information; and
calibrate the sensors in the sensor arrangement based upon the extracted position information.

2. The monitor device of claim 1, wherein the monitor device comprises a traffic light, the traffic light comprising a plurality of lights coupled to the processing unit for control thereby.

3. The monitor device of claim 1, further comprising a transceiver coupled to the processing unit, wherein the instructions stored in the memory, when executed by the processing unit, further cause the processing unit to, following the calibrating of the sensors, receive from the sensors second sense data of objects in the at least one field of view of the sensors, detect, from the second sense data, the objects in the at least one field of view of the sensors, and extract position information of the objects of the second sense data relative to the monitor device based in part upon the extracted position information for each marker, and to communicate, using the transceiver, information pertaining to the sensed objects of the second sense data and the extracted position information thereof.

4. The monitor device of claim 3, wherein the transceiver communicates the information pertaining to the sensed objects of the second sense data and the extracted position information thereof to one or more other monitor devices.

5. The monitor device of claim 3, wherein the transceiver communicates the information pertaining to the sensed objects of the second sense data and the extracted position information thereof to one or more vehicles within a communication range of the monitor device.

6. The monitor device of claim 1, wherein the instructions stored in the memory, when executed by the processing unit, further cause the processing unit to, following the calibrating of the sensors, receive from the sensors a second sense data of objects in the at least one field of view of the sensors, detect, from the second sense data, the objects in the at least one field of view of the sensors and extract position information of the objects of the second sense data relative to the monitor device based at least in part upon the extracted position information for each marker.

7. The monitor device of claim 1, further comprising a transceiver coupled to the processing unit, wherein the at least one marker comprises at least one passive marker and at least one active marker, and wherein the instructions stored in the memory, when executed by the processing unit, further cause the processing device to
receive, via the transceiver, position information from the at least one active marker, and
associate the at least one active marker with the position information received therefrom,
wherein the instructions to calibrate the sensors in the sensor arrangement calibrates the sensors based upon the position information of the at least one active marker.

8. The monitor device of claim 1, wherein the at least one field of view of the sensors comprises a plurality of fields of view thereof, such that the instructions for the receiving, the detecting, the extracting and the calibrating are repeated for each field of view.

9. The monitor device of claim 8, wherein the instructions for the receiving, the detecting, the extracting and the calibrating are performed for a first field of view of the plurality of fields of view before the instructions for the receiving, the detecting, the extracting and the calibrating are performed for a second field of view of the plurality of fields of view.

10. A method, comprising:
sensing, using sensors, one or more first objects in at least one field of view and generating sense data from the sensing;
detecting, from the sense data, at least one marker disposed in a fixed position within the at least one field of view;
for each marker detected, extracting position information corresponding to the marker relative to the sensors, and associating the marker with the extracted position information therefor; and
calibrating the sensors based upon the extracted position information for each marker detected.

11. The method of claim 10, further comprising:
following the calibrating, sensing one or more second objects in the at least one field of view and generating second sense data from the sensing; and
extracting position information of the one or more second objects relative to the sensors based upon the extracted position information for each marker detected.

12. The method of claim 11, further comprising sending information pertaining to the second objects and the extracted position information thereof to one or more monitor devices.

13. The method of claim 11, further comprising sending information pertaining to the second objects and the extracted position information thereof to one or more vehicles within a communication range.

14. The method of claim 10, further comprising receiving position information from at least one active marker and associating the at least one active marker with the position information received therefrom, wherein calibrating the sensors is also based upon the position information of the at least one active marker.

15. The method of claim 10, further comprising, following the calibrating, sensing, by the calibrated sensors, one or more second objects in the at least one field of view and generating second sense data from the sensing; and extracting position information of the one or more second objects relative to the sensors.

16. The method of claim 10, wherein the at least one field of view comprises at least a first field of view and a second field of view, and the sensing, the detecting, the extracting and the calibrating are performed for each field of view.

17. The method of claim 16, wherein the sensing, the detecting, the extracting and the calibrating are performed for the first field of view prior to the sensing, the detecting, the extracting and the calibrating being performed for the second field of view.

18. The method of claim 10, wherein the calibrating includes, for each marker detected, comparing the extracted position information for the marker with known position information of the marker, wherein the sensors are calibrated based upon each comparison.

19. A software program stored in a non-transitory medium and having instructions which, when executed by a processing unit coupled to a sensor arrangement, cause the processing unit to:
receive, from the sensor arrangement, sense data of objects in the at least one field of view of the sensor arrangement;
detect, in the sense data, at least one marker disposed in a fixed position within the at least one field of view;
for each marker detected, extract position information between the marker and the monitor device, and associate the marker with the extracted position information; and
calibrate sensors in the sensor arrangement based upon the extracted position information.

20. The software program of claim 19, further including instructions which, when executed by the processing unit, cause the processing unit to receive position information from at least one active marker and associate the at least one active marker with the position information received therefrom, wherein the instructions for calibrating the sensors calibrate the sensors based in part upon the position information of the at least one active marker.

21. The software program of claim 19, wherein the at least one field of view comprises at least a first field of view and a second field of view, and the instructions cause the sensing, the detecting, the extracting and the calibrating to be performed for each field of view.

22. The software program of claim 19, wherein the instructions to calibrate the sensors in the sensor arrangement include instructions which, for each marker, compares the extracted position information for the marker with known position information thereof, such that the sensors are calibrated based in part upon each comparison.
